(19) United States
(12) Patent Application Publication
(10) Pub. No.: US 2020/0352210 A1
(43) Pub. Date: Nov. 12, 2020

(54) RECEIVER WITH DESTICKER

(71) Applicant: ORCHARD-RITE LTD., INC., Union Gap, WA (US)

(72) Inventor: Michael Britt Gohl, Yakima, WA (US)

(21) Appl. No.: 16/408,130

(22) Filed: May 9, 2019

(51) Int. Cl. A23N 15/00; A01D 46/26; B07B 1/10

(52) U.S. Cl. CPC A23N 15/00; B07B 1/10; A01D 46/26

(57) ABSTRACT

Systems, devices, and methods for harvesting one or more crops, such as fruits or nuts are disclosed. A two-piece harvester is disclosed that separates a crop from sticks, leaves, or other foreign debris. A receiver of the two-piece harvester may include a desticker that is configured to separate selected objects (such as fruits and nuts) that have fallen from a tree or otherwise been introduced from other objects (such as sticks, leaves, or other debris) that have fallen from the tree. The desticker may include a conveyor belt with openings sized to allow the selected objects to pass through and to prevent the other objects from passing through. The desticker may also include one or more impeders or agitators to move, shift, tumble, or jostle the objects being conveyed by the conveyor belt and thereby cause some objects to pass through the conveyor belt.

### TECHNICAL FIELD

The following relates generally to a two-piece harvester that is for harvesting crops from trees, and more specifically to a receiver having a desticker for sifting crops and other debris.

### BACKGROUND

Some nuts and fruit (e.g., almonds, pistachios, macadamias, olives, cherries, prunes, or other tree crops) may be harvested using various methods, including using a two-piece harvester, which may include a shaker component and a receiver component. While harvesting the nuts or fruit, various objects such as sticks and leaves may fall from the tree along with the nuts or fruit. Improved techniques for sifting these sticks and leaves are desired.

### SUMMARY

The described techniques relate to improved systems, devices, or apparatuses for harvesters, and more specifically for two-piece harvesters. Generally, the described systems, devices, apparatuses, or methods relate to harvesting one or more crops, such as fruits or nuts. A two-piece harvester is disclosed that separates crops (e.g., fruits or nuts) from sticks, leaves, or other debris. A receiver of the two-piece harvester may include a desticker that is configured to separate selected objects (such as fruits and nuts) that have fallen from the tree from other objects (such as sticks, leaves, or other debris) that have fallen from the tree or are otherwise present from the environment. The desticker may include a conveyor belt with openings sized to allow the selected objects to pass through and to prevent the other objects from passing through. The desticker may also include one or more impeders or agitators to move, shift, tumble, or jostle the objects being conveyed by the conveyor belt and thereby cause some objects to pass through the conveyor belt as well as prevent damage to the objects that have passed through the conveyor belt.

In one example, a receiver may include a deflector configured to direct objects falling from a tree, a first conveyor configured to receive the objects from the deflector, a desticker positioned at an end of the first conveyor and configured to separate fruits or nuts of the objects from sticks of the objects, the desticker including, an impeder to impede movement of the fruits or nuts as the conveyor belt conveys the objects away from the first conveyor, an agitator positioned between a top portion of the conveyor belt and a bottom portion of the conveyor belt and configured to disturb a motion of the objects conveyed by the conveyor belt, and a second conveyor configured to receive the fruits or nuts from the conveyor belt of the desticker.

In some examples of the receiver described herein, the desticker may include a second impeder positioned between the first conveyor and the impeder and configured to impede movement of the fruits or nuts as the conveyor belt conveys the objects away from the first conveyor.

In some examples of the receiver described herein, the desticker may include a second deflector positioned beneath a distal end of conveyor belt and configured to direct the fruits and nuts to the second conveyor.

In some examples of the receiver described herein, a first end of the desticker adjacent with the first conveyor may be positioned at a first height and a second end of the desticker opposite the first end may be positioned at a second height higher than the first height.

In some examples of the receiver described herein, the desticker may include a pulley configured to cause the top portion of the conveyor belt to move in a first direction and the bottom portion of the conveyor belt to move in a second direction different than the first direction. In some examples of the receiver described herein, the pulley may be configured to rotate in a first rotational direction, and the agitator may be configured to rotate in a second rotational direction different than the first rotational direction.

In some examples of the receiver described herein, the agitator may include a disk configured to rotate, and a set of beams coupled with the disk and each beam configured to periodically contact the conveyor belt based on a rotation of the disk.

In some examples of the receiver described herein, the bottom portion of the conveyor belt may be configured to move the fruits or nuts in a direction away from a distal end of the desticker and across a surface of the second conveyor.

In some examples of the receiver described herein, the desticker may be configured as a first deleafer to separate leaves of the objects from the fruits or nuts, and the set of openings of the conveyor belt may be sized to separate the fruits and nuts from the leaves. In some examples of the receiver may include a second deleafer to separate the leaves from the fruits or nuts after the fruits or nuts may have traveled at least partially along the second conveyor. In some examples of the receiver described herein, the second deleafer includes a blower configured to blow air across the fruits and nuts as the fruits and nuts fall from the second conveyor.

In some examples of the receiver described herein, the conveyor belt of the desticker may be configured to be taut as it conveys the objects from the first conveyor to a distal end of the desticker.

In some examples of the receiver described herein, the receiver may be configured to move in a first direction of travel, and the desticker may be configured to deposit the sticks on the ground behind the receiver in an opposite direction of the first direction of travel.

In some examples of the receiver described herein, the desticker extends for a first length from a proximal end to a distal end, the first length being less than a second length of the first conveyor.

A method for sifting a selected objected from other objects is described. The method may include operations, features, means, or instructions for conveying, by a first conveyor, objects fallen from a tree, separating, by a desticker positioned after the first conveyor, fruits or nuts of the objects from sticks and leaves of the objects, conveying, by a second conveyor positioned at least partially below the desticker, the fruits or nuts away from the desticker, and depositing the fruits or nuts in a bin or on the ground based on conveying the fruits or nuts by the second conveyor.

In some examples of the method described herein, separating the fruits or nuts from the sticks and the leaves further may include operations, features, means, or instructions for agitating, by an agitator of the desticker, a motion of a conveyor belt of the desticker to cause the fruits or nuts to fall through openings in the conveyor belt.

Some examples of the method described herein may further include operations, features, means, or instructions for spreading, by a conveyor belt of the desticker, the fruits or nuts across a surface of the second conveyor, where conveying, by the second conveyor, the fruits or nuts may be based on spreading the fruits or nuts across the surface of the second conveyor.

Some examples of the method described herein may further include operations, features, means, or instructions for deleafing, by a blower, the fruits or nuts after the fruits or nuts may be conveyed by the second conveyor, where depositing the fruits or nuts may be based on deleafing the fruits or nuts.

In some examples of the method described herein, separating the fruits or nuts from the sticks and the leaves further may include operations, features, means, or instructions for impeding, by an impeder of the desticker, the movement of the fruits or nuts along a conveyor belt of the desticker.

In one example, a device or system may include a shaker configured to shake objects from a tree, and a receiver configured to receive the objects fallen from the tree. The receiver may further include a first conveyor configured to receive the objects, a desticker positioned at an end of the first conveyor and configured to separate fruits or nuts of the objects from sticks of the objects, and a second conveyor configured to receive the fruits or nuts from the conveyor belt of the desticker. The desticker may further include an impeder to impede movement of the fruits or nuts as the conveyor belt conveys the objects away from the first conveyor, and an agitator positioned between a top portion of the conveyor belt and a bottom portion of the conveyor belt and configured to disturb a motion of the objects conveyed by the conveyor belt.

### BRIEF DESCRIPTION OF THE DRAWINGS

FIG. 1 illustrates an example diagram of a multi-unit harvesting technique using a two-piece harvester that includes a shaker and a receiver with a desticker in accordance with aspects of the present disclosure.

FIG. 2 illustrates an example of a perspective view of a receiver that includes a desticker in accordance with aspects of the present disclosure.

FIG. 3 illustrates an example of a perspective view of a desticker of a receiver in accordance with aspects of the present disclosure.

FIG. 4 illustrates an example of a perspective view of a cross-section of receiver taken along the line 4-4 including a desticker in accordance with aspects of the present disclosure.

FIG. 5 illustrates an example a side-elevation view of a cross-section of receiver taken along the line 4-4 including a desticker in accordance with aspects of the present disclosure.

FIG. 6 illustrates an example of a perspective view of a receiver that includes a desticker in accordance with aspects of the present disclosure.

FIG. 7 illustrates an example of an elevation view of a receiver that includes a desticker in accordance with aspects of the present disclosure.

FIG. 8 illustrates an example of a process flow for operating a receiver with a desticker in accordance with aspects of the present disclosure.

### DETAILED DESCRIPTION

Systems, devices, and methods for harvesting fruits or nuts, among other crops, are disclosed. Some fruits or nuts, such as almonds, grow on trees. A two-piece harvester is disclosed that separates crops (e.g., fruits or nuts) from sticks, leaves, or other foreign debris. The two-piece harvester may include a shaker configured to shake a tree and cause objects to fall from the tree and a receiver configured to collect the fallen objects and, in some examples, deposit the objects on the ground or in bins.

Various problems may occur, however, with harvesting crops—particularly those from trees. Often the desired part of the harvest (e.g., fruit, nuts) is mixed in with or even attached to other debris (e.g., sticks, leaves). Other techniques require processing in off-site plants, which presents many challenges and increases costs, or using inferior and ineffective attempts to separate the desired parts of the harvest from the other debris. These inferior and ineffective alternatives may lead to destroying parts of the harvested crops or other problems and have created a need for improved techniques and equipment to aid in harvesting. These improved techniques and components are described herein.

The receiver may include a desticker for separating selected objects (such as fruits and nuts) that have fallen from the tree from other objects (such as sticks, leaves, or other debris) that have fallen from the tree or are otherwise present from the environment. The desticker may include a conveyor belt with openings sized to allow the selected objects to pass through and to prevent the other objects from passing through. The desticker may also include one or more impeders or agitators to move, shift, tumble, or jostle the objects being conveyed by the conveyor belt and thereby cause some objects to pass through the conveyor belt as well as prevent damage to the objects that have passed through the conveyor belt.

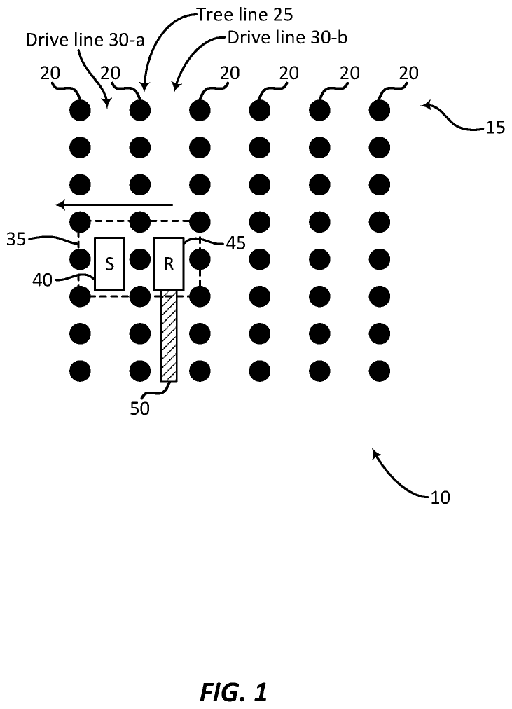

FIG. 1 illustrates an example diagram 10 of multi-unit harvesting techniques for an orchard 15 in accordance with aspects of the present disclosure. The orchard 15, as one example of a harvesting area, may include a plurality of trees 20 (or bushes or other plants) configured in a plurality of tree lines 25 and a plurality of drive lines 30. A tree line 25 may include a plurality of trees 20 that grow fruits or nuts. A drive line 30 may be configured to allow equipment such as harvesters, shakers, receivers, pick-up machines, or combinations thereof, to access individual trees 20 of the orchard 15.

A harvesting unit 35 operating in the orchard 15 may include a shaker 40 and a receiver 45. When harvesting a plurality of trees 20 in a tree line 25, the shaker 40 may travel along a first drive line 30-a positioned on a first side of the tree line 25 and a receiver 45 may travel along a second drive line 30-b on a second side of the tree line 25 (e.g., which may be opposite the first side). When harvesting a fruit or nut of a tree 20, both the shaker 40 and the receiver 45 may be positioned next to the same tree. The shaker 40 may shake the tree 20 and the shaker 40 and/or the receiver 45 may collect the falling fruits or nuts into a conveyor (e.g., a conveyor of the receiver 45). Some nuts and fruit (e.g., almonds, pistachios, macadamias, olives, cherries, prunes, or other crops) may be harvested using the harvesting unit 35. The shaker 40 may be configured to grasp a tree 20 and mechanically shake the tree 20 to cause fruits or nuts in the tree to fall. The shaker 40 may include a shaker head that may include jaws or pincers that clamp onto a portion of the tree 20 (e.g., the trunk of a tree). A mechanical motor coupled with the pincers may be configured to cause the tree 20 to shake after the pincers are clamped onto the tree 20.

The harvesting unit 35 may be configured to collect the fruits or nuts falling from the tree 20 while mitigating damage to the fruits or nuts caused by falling. A shaker 40 may be positioned on a first side of the tree 20 and the receiver 45 may be positioned on a second side of the tree 20. The shaker 40 and the receiver 45 may include one or more deflectors configured to intercept objects falling from the tree 20 before they reach the ground and direct the objects (e.g., sticks, leaves, fruits, or nuts) to one or more conveyors of the receiver 45. In some examples, a covering (e.g., such as a tarp, cloth, or other component to soften the force the falling crops experience) may be positioned over the deflectors to further protect the falling nuts or fruit.

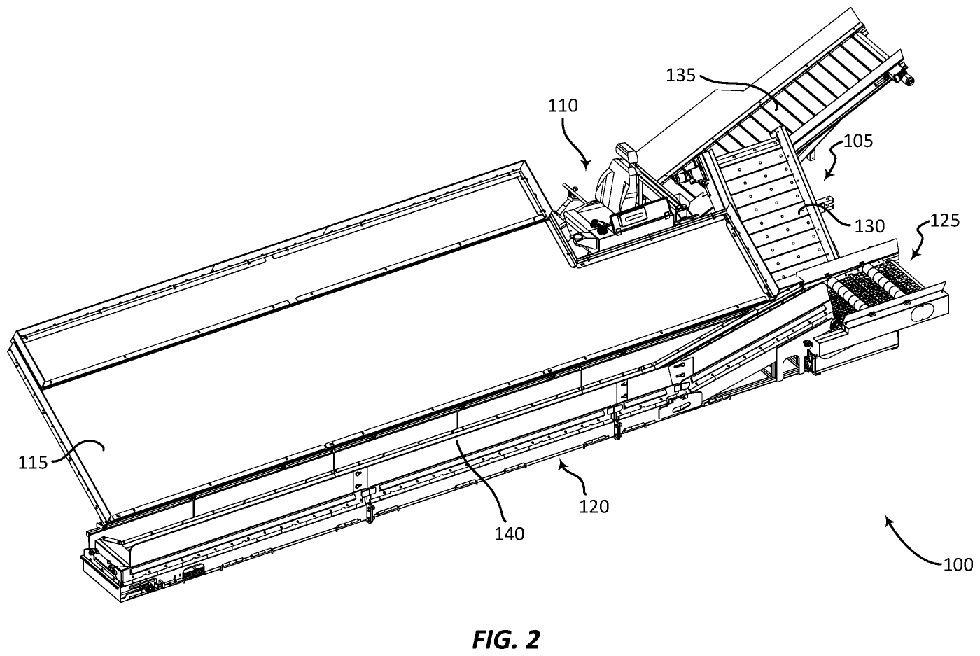

One or more conveyors of the receiver 45 may be configured to deposit the nuts or fruit in a desired location such as a ground surface or a bin. The conveyors may include one or more motors, rollers, pulleys, and/or belts to move the fruits or nuts. The conveyors may include one or more portions. A first conveyor may move nuts from a first end of the receiver 45 toward a second end of the receiver 45. A second conveyor may move nuts from the first portion to a third conveyor or a chute that deposits the fruits or nuts on the ground or in a bin. In some examples, the third conveyor or the chute may be configured to deposit the fruits or nuts in different places based on the direction of travel of the receiver 45. In some examples, a desticker and/or deleafer may be positioned between the first conveyor and the second conveyor and may be configured to separate the desired crop from sticks, leaves, or other debris. The desticker and/or deleafer may include a variety of features to sift crops from debris including a conveyor belt with openings sized to allow some objects to pass through and prevent other objects from passing through, an incline, impeders, agitators, or a combination thereof. Additional details and features of the desticker and/or deleafer are described with reference to FIGS. 2-8.

Some fruits or nuts may be allowed to dry before hulling and/or shelling occurs. For example, almonds may be allowed to dry in the sun for an extended period (e.g., several days or weeks) to ensure that the moisture content of the almond is correct for hulling and/or shelling. The receiver 45 may be configured to deposit the fruits or nuts (e.g., almonds) on the ground in a windrow 50 in the drive line 30-b. A windrow may be a row of a harvested crop (e.g., almonds) that is allowed to dry before being processed further (e.g., hulled, shelled, combined, baled, or rolled). In some examples, the receiver 45 may be configured to deposit the fruits or nuts in bins. The bins containing the fruits or nuts may be deposited in the drive line 30-b. To harvest the crop from the trees 20 of the orchard 15, the harvesting unit 35 may move from tree 20 to tree 20 along the tree lines 25. When doing this, the shaker 40 of the harvesting unit 35 may shake each tree 20 that is harvested and may deflect the falling crops (e.g., fruits or nuts) into the receiver 45 of the harvesting unit 35.

In some examples, to prevent damage to the harvested crop in a windrow, to the trees in the orchard, or other damage that may occur to equipment, crops, or land, the shaker 40 and/or the receiver 45 may include a moveable cab. The cabs may be moveable to increase the visibility of the operator during different types of operations. For example with the moveable cabs, the operator may be able to see the tree and/or any windrows of crop on the ground. Further, the moveable cabs may be configured to better allow the shaker 40 and the receiver 45 to move bidirectionally along a drive line 30. A shaker 40 may also include an extendible wheel configured to avoid crushing a crop in a windrow 50 deposited in a drive line 30. A receiver 45 may be configured with a chute that may be configured to selectively deposit the crop in the windrow 50 in different locations based on the direction of travel of the receiver 45.

After the crop has dried sufficiently, a pick-up machine may collect the crop in the windrows and transport the crop to other processing facilities. For example, for almonds, a pick-up machine may transport the almonds to a huller/sheller facility. The almonds may be prepared hulled and/or shelled and such a facility and in other ways prepared for sale.

FIG. 2 illustrates an example of a perspective view of a receiver 100 that includes a desticker in accordance with aspects of the present disclosure. The receiver 100 may be an example of the receiver 45 described with reference to FIG. 1.

The receiver 100 may be configured to collect objects (such as fruits, nuts, sticks, leaves) that may fall from a tree or other foliage, among other examples, and may deposit the objects in a desired location such as the ground or a bin. The receiver 100 may include a frame 105, a cab 110, one or more deflectors 115, a first conveyor 120, a desticker 125, a second conveyor 130, and a third conveyor 135 in some examples. In some examples, the receiver 100 may include a chute in place of the third conveyor 135.

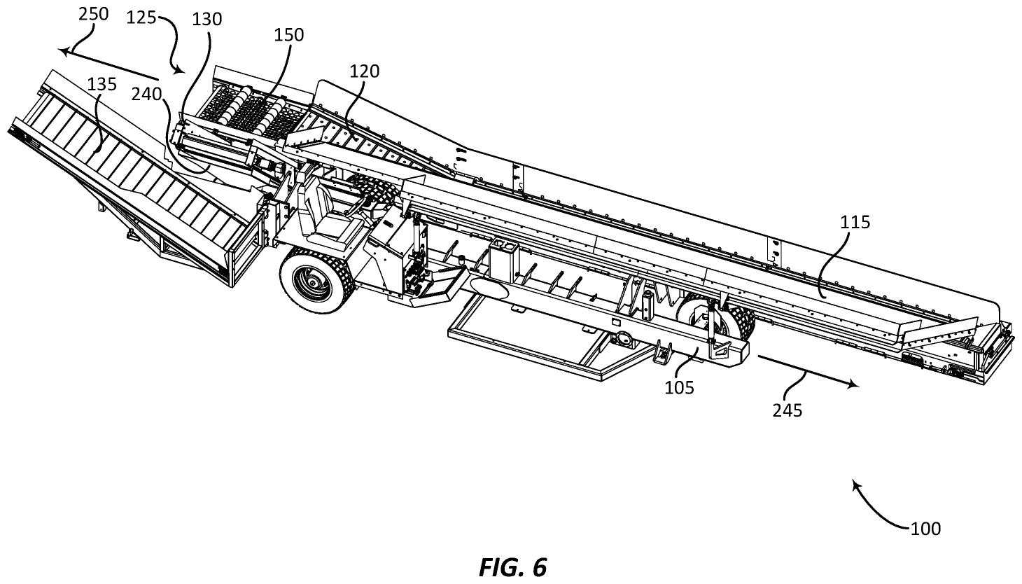

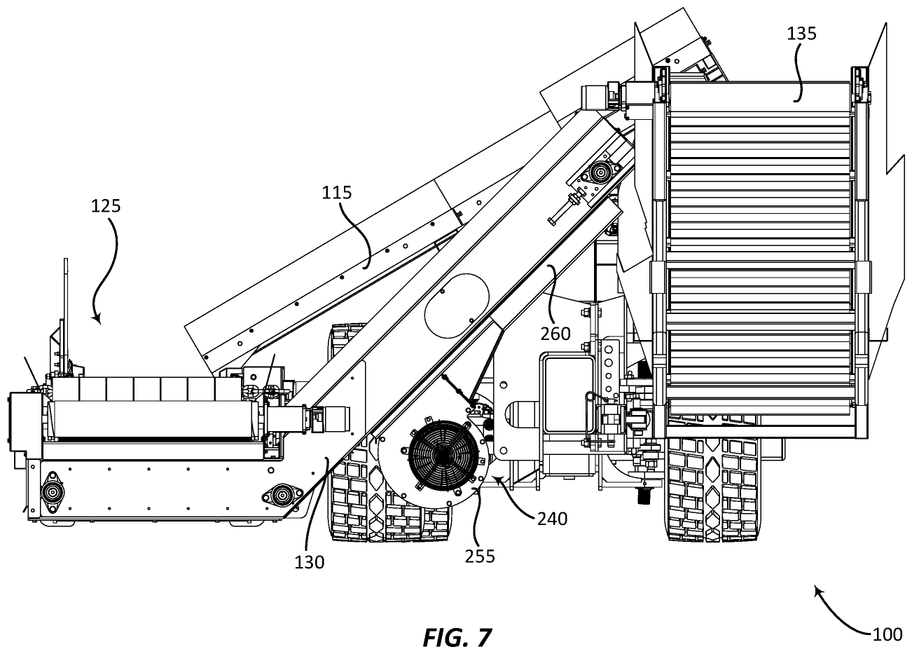

The frame 105 may be a main supporting structure of the receiver 100. The frame 105 may be configured to support mechanical components of the receiver 100 and to deal with static and dynamic loads, without undue deflection or distortion. The frame 105 may include one or more beams or rails. Additional features of the frame 105 are shown in FIGS. 6 and 7.

The cab 110 may be coupled with the frame 105. The cab 110 may include one or more controls for an operator of the receiver 100. In some examples, the cab 110 may include a chair, a steering wheel, other controls, and/or a canopy. In some examples, the cab 110 may be rotatable relative to the frame 105.

The one or more deflectors 115 of the receiver 100 may be configured to deflect falling objects (e.g., fruits, nuts, sticks, leaves) onto the first conveyor 120 of the receiver 100. The receiver 100 may include any number of deflectors 115 (e.g., one, two, three, four, five, six, seven, eight). The deflector 115 may, in some examples, be repositionable. For example, deflector 115 may be configured to move up-and-down or laterally away from or toward the first conveyor 120. The deflectors 115 may be sized to extend beyond the dimensions of an area such as the canopy of the tree, or of an area that includes at least the canopy of a first side of the tree. The deflectors 115 may be configured to be positionable based on the canopy of the tree being harvested. The deflectors 115 of the receiver 100 and deflectors of a shaker may be used to intercept objects falling from the same tree. For example, the deflectors of the shaker may be positioned under a first portion of the canopy of the tree being harvested and the deflectors 115 of the receiver 100 may be positioned under a second portion of the canopy of the tree being harvested. Both the deflectors of the shaker and the deflectors 115 of the receiver 100 may direct objects falling from the tree into the first conveyor 120 of the receiver 100.

At least some of, if not all of the one or more deflectors 115 and the first conveyor 120 may be repositionable. In some examples, the one or more deflectors 115 may be attached (e.g., via a hinge) to the first conveyor 120. In some examples, the repositioning may be performed concurrently or in unison (e.g., if performed for multiple components). In some examples, the repositioning may be independent for each component (e.g., the repositioning of at least one deflector 115 may be independent of the first conveyor 120). For example, the ‘rear’ of the deflector 115 (opposite side of conveyor) may be moved up and down and the ‘front’ of the deflector 115 may also be independently moved up and down. This allows an angle of the deflector 115 relative to the first conveyor 120 to change and a height of the deflector 115 and the first conveyor 120 to change.

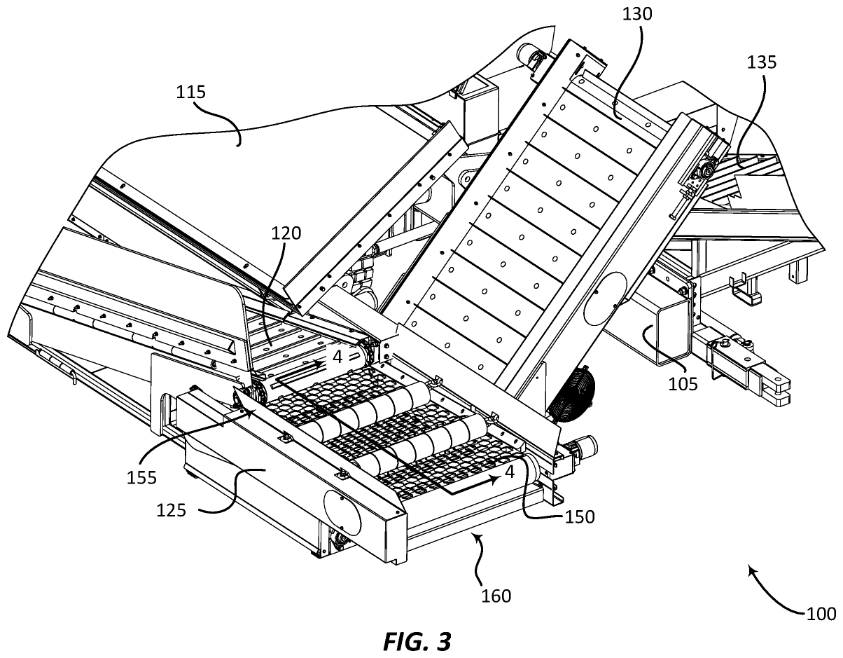

The first conveyor 120 of the receiver 100 may be configured to collect the objects deflected by the deflectors 115 of the receiver 100 and the deflectors of the shaker. The first conveyor 120 may extend along the length of the receiver 100 and may be positioned on the side of the receiver 100 to be closest to the tree. The first conveyor 120 may be configured as the collector point for the two-piece harvester. The first conveyor 120 may be configured to move objects (e.g., fruits, nuts, other crops, sticks, leaves, other debris) to a desticker 125. A portion of the first conveyor 120 may be inclined to raise the objects to a higher vertical position. Portions of the first conveyor 120 illustrated in FIG. 2 may be obscured by a retaining wall 140 configured to prevent objects from falling off of the first conveyor 120. Other aspects of the first conveyor 120 are shown and described with reference to FIGS. 3-6.

The desticker 125 may be configured to separate or sift crops (e.g., fruits or nuts) from debris (e.g., sticks and leaves) collected by the first conveyor 120. The desticker 125 may be positioned at one end of the first conveyor 120. The desticker 125 may receive objects deposited by the first conveyor 120. A component of the desticker 125, such as a mesh belt of the desticker 125, may be configured to allow fruits or nuts of the objects to pass through and, in some examples, onto the second conveyor 130. The mesh belt of the desticker 125 may also be configured to transport sticks, leaves, and other debris away from the second conveyor 130. In this manner, the desticker 125 may separate fruits or nuts from sticks, leaves, and other debris. In some examples, the desticker 125 may be a first length that is different than (e.g., less than) a second length of the first conveyor 120.

The second conveyor 130 may be configured to move the fruits or nuts up and over the receiver 100 to the far side of the receiver 100 to be deposited on the ground or in bins. A first portion of the second conveyor 130 may be positioned under the desticker 125 and may be configured to receive fruits or nuts that pass through the desticker 125. The second conveyor 130 may deposit fruits or nuts on a third conveyor 135 or chute.

The third conveyor 135 may be configured to deposit the fruits or nuts on the ground or in bins. In some examples, the third conveyor 135 may be configured deposit fruits or nuts in different directions based on the direction of travel of the receiver 100. For example, the third conveyor 135 may be configured to deposit the fruits or nuts in the direction that is opposite the direction of travel of the receiver 100. In some examples, the third conveyor 135 may be replaced by a chute. The conveyors 120, 130, and 135 and the desticker 125 may include one or more motors, rollers, pulleys, and/or belts to move the objects that have fallen from the tree.

FIG. 3 illustrates an example of a perspective view of the desticker 125 of the receiver 100 in accordance with aspects of the present disclosure. The desticker 125 is positioned on the receiver 100 and is configured to separate fruits and nuts from other debris (e.g., leaves and sticks) that fall from the tree during harvesting.

The desticker 125 may include a conveyor belt 150 that may include one or more openings. The openings of the conveyor belt 150 are sized to allow fruits or nuts to pass through the mesh belt and to prevent other debris (e.g., sticks and leaves) from passing through the conveyor belt 150. The openings of the conveyor belt 150 may form a mesh or a sifter and, in some cases, the conveyor belt 150 may be referred to as a mesh conveyor belt. Different conveyor belts may be used for different fruits or nuts. In such examples, different conveyor belts may have different sized openings based on the size of the fruits or nuts being harvested (e.g., they may have smaller openings related to the size of the fruits or nuts to be harvested as compared to other conveyor belts that may have larger openings).

The desticker 125 may include a proximal end 155 positioned near to (e.g., adjacent to) the first conveyor 120 and a distal end 160 positioned away from the first conveyor 120. The conveyor belt 150 may be configured to move and convey objects from the proximal end 155 to the distal end 160. As the conveyor belt 150 moves, the fruits or nuts may be jostled, shifted, or moved such that the fruits or nuts align with the openings and fall through the openings in the conveyor belt 150. The openings of the conveyor belt 150 may be configured to sift the fruits and nuts from sticks, leaves, and other debris.

In some examples, the first conveyor 120, the second conveyor 130, or the third conveyor 135 may include incline belting systems. In some examples, the belting systems may include cleats rough tops, or other features to move objects up inclines.

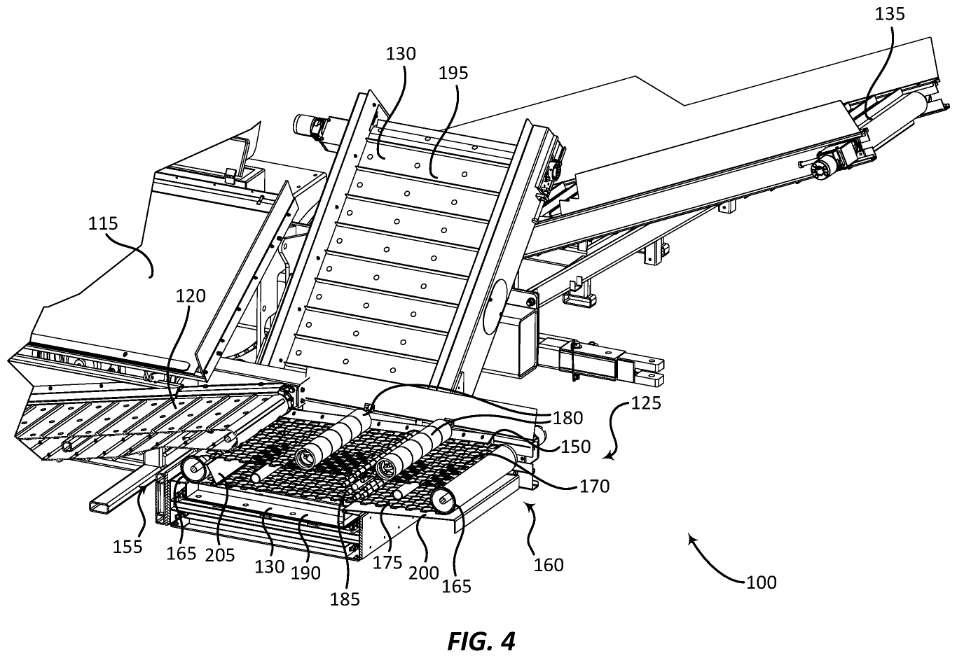

FIG. 4 illustrates an example of a perspective view of a cross-section of receiver 100 taken along the line 4-4 including the desticker 125 in accordance with aspects of the present disclosure. FIG. 4 illustrates how the desticker 125 may be configured to receive objects from the first conveyor 120, deposit selected objects on the second conveyor 130, and discharge other objects over the distal end 160.

The desticker 125 may include two or more pulleys 165 configured to cause the conveyor belt 150 to move. In some examples, one pulley 165 may be a drive pulley that rotates in response to movement of a motor. In some cases, the direction of motion of the conveyor belt 150, the speed of motion of the conveyor belt 150, or both may be adjustable. The drive pulley may cause a top portion 170 of the conveyor belt 150 to move in a first direction (e.g., from the proximal end 155 to the distal end 160) and a bottom portion 175 of the conveyor belt 150 to move in a second direction opposite the first direction (e.g., from the distal end 160 to the proximal end 155). The two or more pulleys 165 may be configured to set or keep tension on the conveyor belt 150. In some examples, the conveyor belt 150 may be taut (e.g., not slack) as it moves between the two or more pulleys 165. By having the conveyor belt 150 be taut rather than slack it may allow the desticker 125 be shorter than conveyor belts that have slack or droops. Further, such a configuration may reduce the vertical profile of the desticker 125. Some receivers may have space constraints due to receivers 100 being transported by other vehicles (e.g., semi-trucks, trains), the receivers 100 having to handle uneven terrain at times, that receivers 100 need to fit within drive lines of fields or orchards. Maintaining the dimensions of the desticker 125 within certain limits may be useful for incorporating the desticker 125 into a moving vehicle such as the receiver 100.

The desticker 125 may include one or more impeders 180 positioned above the top portion 170 of the conveyor belt 150. When objects are placed on the conveyor belt 150 (or any object that acts as a sifter), the objects may obtain a static state and some of the desired objects may not be sifted or separated properly. To increase a quantity of the desired objects that are separated by the openings or mesh, techniques may be used to disrupt the static state of the objects on the conveyor belt 150. For example, the impeders 180 may be configured to impede the progress of the objects being conveyed by the conveyor belt 150 and thereby cause the objects traveling along the conveyor belt 150 to change course, jostle, shift, or any combination thereof. As the objects are impeded, some objects such as fruits or nuts may fall through the openings in the conveyor belt 150. In some examples, the impeders 180 may be or include examples of chains strung across the conveyor belt 150 with a casing over the chains. The impeders 180 may take on any structure including poles, cylinders, or tubes, among other examples. The desticker 125 may include any quantity of impeders 180 (e.g., one, two, three, four, five, six). In the illustrative example, the desticker 125 includes two impeders 180. The greater the number of the impeders 180, the more opportunities that the desticker 125 may have to disrupt a static state of objects on the conveyor belt 150 and cause objects to pass through the conveyor belt 150 and onto the second conveyor 130.

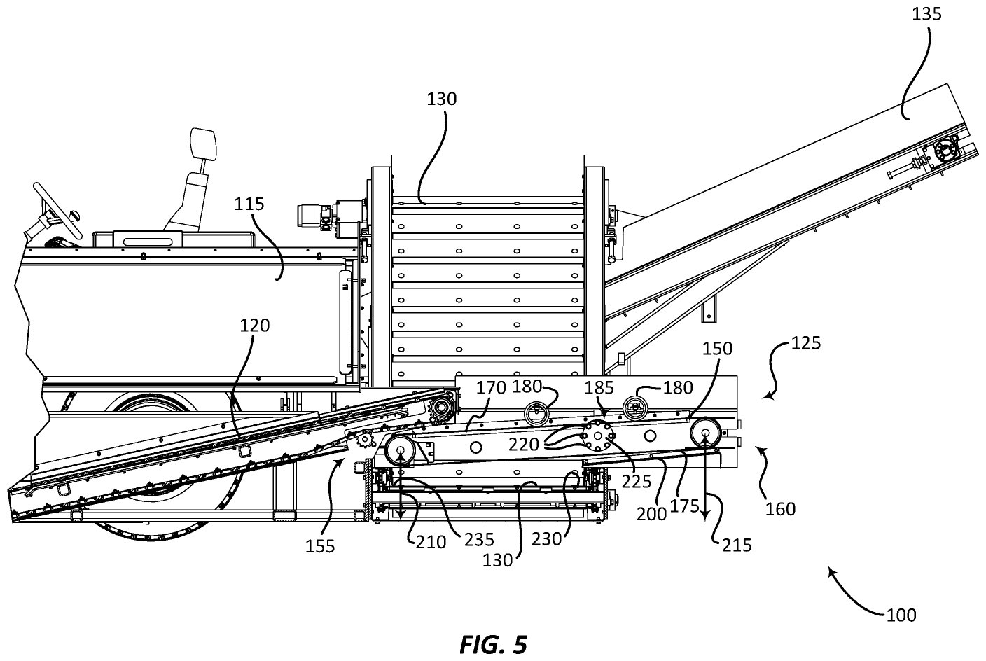

The desticker 125 may include an agitator 185 configured to move, jostle, or shift the conveyor belt 150 as it moves. By agitating the conveyor belt 150, the objects traveling along the conveyor belt 150 may be caused to change course, jostle, tumble, shift, or any combination thereof. The agitator 185 may be configured to disrupt a static state of objects on the conveyor belt 150 and cause objects to pass through the conveyor belt 150 and onto the second conveyor 130. The agitator 185 may be positioned between the top portion 170 and the bottom portion 175 of the conveyor belt 150. Additional details and features of the agitator 185 are described with reference to FIG. 5.

The desticker 125 is configured to position selected objects (e.g., fruits, nuts, or other crops) on the second conveyor 130. The second conveyor 130 may include a first portion 190 that may be positioned below the desticker 125. In some examples, the first portion 190 of the second conveyor 130 may be approximately level relative to the ground. A second portion 195 of the second conveyor 130 may be inclined (e.g., non-horizontal) to move objects up and over the frame 105 of the receiver 100 and to the third conveyor 135.

The desticker 125 may include a first deflector 200 configured to direct objects back to the second conveyor 130. The desticker 125 may be longer than the second conveyor 130 is wide. In such examples, portions of the desticker 125 may extend beyond the second conveyor 130. If fruits or nuts fall through the openings in the portion of the conveyor belt 150 that is not above the second conveyor 130, the first deflector 200 is configured to direct these objects back to the second conveyor 130.

The desticker 125 may also include a second deflector 205 configured to prevent objects from being damaged by the pulleys 165 of the conveyor belt 150. To reach the second conveyor 130, objects must pass through the top portion 170 of the conveyor belt 150 and the bottom portion 175 of the conveyor belt 150. If objects pass through the top portion 170 but not the bottom portion 175, the objects may be moved toward one of the pulleys by the conveyor belt 150. Objects may be pinched, crushed, or damaged by the interaction between the pulleys 165 and the conveyor belt 150. The second deflector 205 may be configured to impede the progress of objects to prevent the objects from being damaged by a pulley 165 or the conveyor belt 150. The second deflector 205 may be configured to cause the objects traveling between the top portion 170 and the bottom portion 175 of the conveyor belt 150 to change course, jostle, shift, or any combination thereof. As the objects are jostled, some objects such as fruits or nuts may fall through the openings in the bottom portion 175 of the conveyor belt 150.

FIG. 5 illustrates an example a side-elevation view of a cross-section of receiver 100 taken along the line 4-4 including the desticker 125 in accordance with aspects of the present disclosure. FIG. 5 illustrates additional features of the desticker 125 that may be configured to sift selected objects from debris and other features.

The desticker 125 may be inclined to cause objects to move, jostle, tumble, shift, or otherwise move and thereby pass through the openings in the conveyor belt 150. For example, a first height 210 at the proximal end 155 of the desticker 125 may be less than a second height 215 at the distal end 160 of the desticker 125. The incline may cause the objects to roll backward, thereby changing their position and increasing a likelihood that selected objects (e.g., fruits or nuts) pass through the openings in the conveyor belt 150. In some cases, the first height 210 or the second height 215 may be adjustable such that a degree of the incline of the conveyor belt 150 may adjustable or the entire conveyor belt 150 system may be raised or lowered. For example, different degrees of incline or different distances away from the first conveyor 120 or the second conveyor 130 may be used based on the type of crop being harvested.

The agitator 185 of the desticker 125 may include one or more beams 220 configured to contact (e.g., periodically contact) the conveyor belt 150. The contact between the beams 220 and the conveyor belt 150 may cause the conveyor belt 150 to move, jostle, or shift the conveyor belt 150 as it travels. By agitating the conveyor belt 150, the objects traveling along the conveyor belt 150 may be caused to change course, jostle, tumble, shift, or any combination thereof. The one or more beams 220 may be coupled with one or more disks 225. The one or more disks 225 may be configured to rotate and thereby cause the beams to move and contact (e.g., periodically contact) or strike the conveyor belt 150. In some examples, the agitator 185 may be positioned such that the one or more beams 220 may break a plane of the top portion 170 of the conveyor belt 150, thereby causing the motion of the conveyor belt 150 to be agitated.

In some implementations, the agitator 185 may rotate in a direction to cause the beams that are contacting the conveyor belt 150 to travel in an opposite direction as the portion of the conveyor belt 150 being contacted. For example, if top portion 170 of the conveyor belt 150 travels in a first direction (e.g., from the proximal end 155 to the distal end 160), the agitator 185 may rotate in a counter-clockwise direction such that the beams 220 may be traveling in a second direction (e.g., from the distal end 160 to the proximal end 155) when the beams 220 are contacting the conveyor belt 150. In other implementations, the agitator 185 may rotate in a direction to cause the beams that are contacting the conveyor belt 150 to travel in the same direction as the portion of the conveyor belt 150 being contacted.

In some examples, the agitator 185 may contact the bottom portion 175 of the conveyor belt 150. In some examples, the agitator 185 may contact both the top portion 170 and the bottom portion 175 of the conveyor belt 150. In some cases, the direction of rotation of the agitator 185 is adjustable or selectable or the speed of rotation of the agitator 185 is selectable or adjustable. In some examples, control of the agitator 185 is independent of control of other features of the desticker 125 (e.g., operation of the conveyor belt 150). In other examples, however, control of the agitator 185 is linked with control of the conveyor belt 150. Other types of agitators may be implemented that are different than the rotational agitator illustrated in FIGS. 4 and 5.

The first conveyor 120 may be positioned above the desticker 125 and a distance beyond the proximal end 155 of the desticker 125. In such a configuration, the first conveyor 120 may be configured to deposit the objects (e.g., fruits, nuts, crops, sticks, leaves, other debris) on the conveyor belt 150 away from one of the ends.

In some examples, the desticker 125 may be configured as a deleafer as well as a desticker. The openings in the conveyor belt 150 may be sized to prevent leaves and/or sticks from passing through the conveyor belt 150. In such configurations, sticks, leaves, and other debris may be discharged off the distal end 160 of the desticker 125 and away from the second conveyor 130.

In some examples, the desticker 125 may be configured to spread objects across the second conveyor 130. In such examples, the desticker 125 may be configured to more uniformly distribute objects across a surface of the second conveyor 130 compared to other techniques or apparatuses. The bottom portion 175 of the conveyor belt 150 may be configured to move in a direction from the distal end 160 to the proximal end 155. As the objects pass through conveyor belt 150, the objects may be more likely to land on one side (e.g., the right side as depicted in FIG. 5). The bottom portion 175 of the conveyor belt 150 may be positioned in such a manner to cause some objects to move from a first position on the second conveyor 130 to a second position on the second conveyor 130. For example, the bottom portion 175 of the conveyor belt 150 may be configured to move objects from the first deflector 200 and from a distal side 230 of the second conveyor 130 toward or to a proximal side 235 of the second conveyor 130. Thus, the bottom portion 175 of the conveyor belt 150 may be configured to move objects along the first deflector 200 toward the second conveyor 130.

FIG. 6 illustrates an example of a perspective view of the receiver 100 that includes the desticker 125 in accordance with aspects of the present disclosure. The receiver 100 may include a deleafer 240 configured to separate leaves and other debris (including sticks, in some examples) from the fruits or nuts of the objects. The deleafer 240 may be configured to blow air through objects falling from the second conveyor 130 to the third conveyor 135. As the objects pass through the air blown by the deleafer 240, lighter objects or parts of objects (such as leaves, leaf fragments, small sticks, small rocks, etc.) may be moved away from the third conveyor 135, while heavier objects (such as fruits or nuts) may pass through the blown air without much adverse movement.

In this manner, the receiver 100 may include two devices that are configured as deleafers. For example, the desticker 125 may be configured as a deleafer (e.g., the desticker may be configured in a way to separate leaves from harvested objects) and the deleafer 240 may be configured as a deleafer (e.g., the deleafer may be configured in a way to separate leaves from harvested objects).

Each device that deleafs, however, may operate using different principles. For example, the desticker 125 may separate leaves from the fruits or nuts based on the openings in the conveyor belt 150 being sized to prevent leaves from passing through the conveyor belt 150, while the deleafer 240 may blow air through falling objects to separate the leaves and other lighter objects from the fruits or nuts. Such a dual function deleafer configuration may be more effective than other solutions that may have a single function, and may further increase the efficacy of these operations.

The third conveyor 135 may be configured discharge objects (including the fruits or nuts) off the receiver 100 in a direction that may be different than the direction of travel of the receiver 100. For example, the receiver 100 may be configured to travel in a first direction 245. The third conveyor 135 may deposit objects in a second direction 250 that is opposite the first direction 245 to prevent the receiver 100 from running over or otherwise damaging the objects discharged from the third conveyor 135. The desticker 125 may also be configured to discharge some objects (such as sticks and leaves) off of the receiver in the second direction 250 opposite the direction of travel (e.g., the first direction 245) of the receiver 100.

FIG. 7 illustrates an example of an elevation view of the receiver 100 that includes the desticker 125 in accordance with aspects of the present disclosure. The elevation view is a rear elevation view of the receiver 100 looking from the end of the receiver 100 that includes the desticker 125 toward the end of the receiver that includes the deflectors 115.

The deleafer 240 may be positioned beneath the second conveyor 130. The deleafer 240 may include a blower 255 and a funnel 260. The blower 255 may be configured generate air movement. The funnel 260 may be configured to direct the air generated by the blower 255 to blow over objects falling from the second conveyor 130 onto the third conveyor 135.

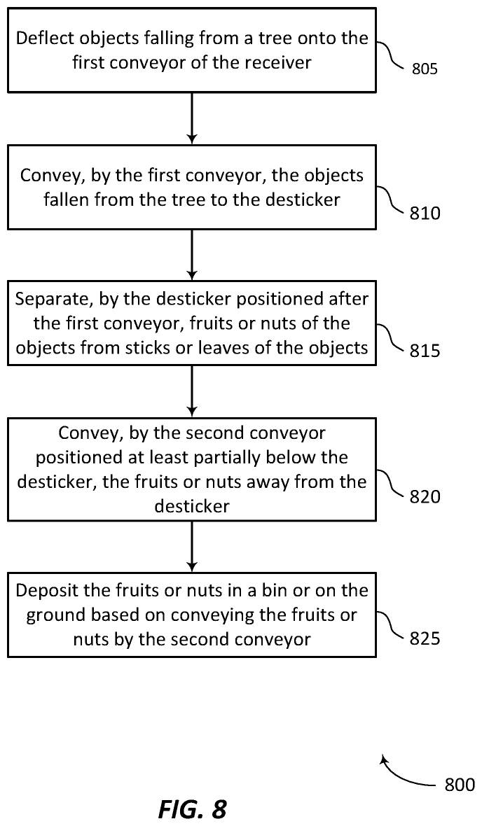

FIG. 8 illustrates an example of a process flow 800 for operating the receiver 100 with the desticker 125 in accordance with aspects of the present disclosure. The process flow 800 illustrates functions or procedures for operating the receiver 100. The functions or procedures may be performed by a user of the receiver 100, a controller of the receiver 100, or a combination thereof. The controller may be any combination of hardware, firmware, or software used to perform functions and/or run algorithms. The controller may communicate with one or more sensors and/or one or more actuators or other devices for determining data and for executing commands.

At block 805, the receiver 100 may deflect objects falling from a tree onto the first conveyor 120 of the receiver 100. The objects received by the first conveyor 120 may be deflected by the deflectors 115 of the receiver, one or more deflectors of a shaker, or a combination thereof. The objects falling from the tree may include a crop (such as fruits or nuts), sticks, leaves, or other debris from the associated environment.

At block 810, the receiver 100 may convey, by the first conveyor 120, the objects fallen from the tree to the desticker 125. The first conveyor 120 may include one or more belts configured to move in response to rotation of one or more pulleys. The first conveyor 120 may include a plurality of portions. A first portion may be approximately level and may extend along the deflectors 115. A second portion may be inclined and may at least partially be positioned over the desticker 125.

At block 815, the receiver 100 may separate, by the desticker 125 positioned after the first conveyor 120, fruits or nuts of the objects from sticks or leaves of the objects. The desticker 125 may be configured to separate sticks from fruits or nuts, leaves from fruits or nuts, or a combination thereof. The desticker 125 may include a conveyor belt 150 that may include one or more openings sized to allow selected objects (e.g., fruits or nuts) to pass through and to prevent other objects (e.g., sticks, leaves, or other debris) from passing through the conveyor belt 150. The receiver 100 may deposit the selected objects (such as fruits or nuts) onto the second conveyor 130 from the desticker 125. The receiver 100 may also discharge the other objects (such as sticks or leaves) off of an end of the desticker 125.

In some examples, to separate the fruits or nuts from the sticks or leaves the receiver 100 may agitate, by an agitator 185 of the desticker 125, a motion of a conveyor belt 150 of the desticker 125 to cause the fruits or nuts to fall through openings in the conveyor belt 150. In some examples, to separate the fruits or nuts from the sticks or leaves the receiver 100 may impede, by one or more impeders 180 of the desticker 125, the movement of the fruits or nuts along the conveyor belt 150 of the desticker 125. In some examples, to separate the fruits or nuts from the sticks or leaves the receiver 100 may deflect, by a first deflector 200 the fruits or nuts that have passed through the conveyor belt 150 onto the second conveyor 130.

At block 820, the receiver 100 may convey, by the second conveyor 130 positioned at least partially below the desticker 125, the fruits or nuts away from the desticker 125. In some examples, the receiver 100 may spread, by the conveyor belt 150 of the desticker 125, the fruits or nuts across a surface of the second conveyor 130, where conveying, by the second conveyor 130, the fruits or nuts is based on spreading the fruits or nuts across the surface of the second conveyor. The second conveyor 130 may deposit the fruits or nuts on the ground, in a bin, on a chute, or another conveyor (e.g., the third conveyor 135), or a combination thereof.

At block 825, the receiver 100 may deposit the fruits or nuts in a bin or on the ground based on conveying the fruits or nuts by the second conveyor. In some examples, the receiver 100 may include a chute that receives the fruits or nuts from the second conveyor 130 and deposits the fruits or nuts in the bin or on the ground. In some examples, the receiver 100 may include a third conveyor 135 that receives the fruits or nuts from the second conveyor 130 and deposits the fruits or nuts in the bin or on the ground.

In some examples, the receiver 100 may optionally deleaf, by a blower 255, the fruits or nuts after the fruits or nuts are conveyed by the second conveyor 130. Depositing the fruits or nuts may be based on deleafing the fruits or nuts using the blower 255.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components, including features that control operations or operating parameters of various devices, described in connection with this disclosure may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Some of the functions described herein may be implemented in hardware, software executed by a processor, firmware, or any combination thereof. If implemented in software executed by a processor, the functions may be stored on or transmitted over as one or more instructions or code on a computer-readable medium.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A receiver, comprising:
a deflector configured to direct objects falling from a tree;
a first conveyor configured to receive the objects from the deflector;
a desticker positioned at an end of the first conveyor and configured to separate fruits or nuts of the objects from sticks of the objects, the desticker comprising:
a conveyor belt that comprises a plurality of openings sized to permit the fruits or nuts to pass through the conveyor belt and to prevent the sticks to pass through the conveyor belt, the conveyor belt configured to convey the objects away from the first conveyor;
an impeder to impede movement of the fruits or nuts as the conveyor belt conveys the objects away from the first conveyor;
an agitator positioned between a top portion of the conveyor belt and a bottom portion of the conveyor belt and configured to disturb a motion of the objects conveyed by the conveyor belt; and
a second conveyor configured to receive the fruits or nuts from the conveyor belt of the desticker.

2. The receiver of claim 1, wherein the desticker further comprises:
a second impeder positioned between the first conveyor and the impeder and configured to impede movement of the fruits or nuts as the conveyor belt conveys the objects away from the first conveyor.

3. The receiver of claim 1, wherein the desticker further comprises:
a second deflector positioned beneath a distal end of conveyor belt and configured to direct the fruits and nuts to the second conveyor.

4. The receiver of claim 1, wherein a first end of the desticker adjacent with the first conveyor is positioned at a first height and a second end of the desticker opposite the first end is positioned at a second height higher than the first height.

5. The receiver of claim 1, wherein the desticker further comprises:
a pulley configured to cause the top portion of the conveyor belt to move in a first direction and the bottom portion of the conveyor belt to move in a second direction different than the first direction.

6. The receiver of claim 5, wherein:
the pulley is configured to rotate in a first rotational direction; and
the agitator is configured to rotate in a second rotational direction different than the first rotational direction.

7. The receiver of claim 1, wherein the agitator further comprises:
a disk configured to rotate; and
a plurality of beams coupled with the disk and each beam configured to periodically contact the conveyor belt based at least in part on a rotation of the disk.

8. The receiver of claim 1, wherein the bottom portion of the conveyor belt is configured to move the fruits or nuts in a direction away from a distal end of the desticker and across a surface of the second conveyor.

9. The receiver of claim 1, wherein:
the desticker is configured as a first deleafer to separate leaves of the objects from the fruits or nuts; and
the plurality of openings of the conveyor belt are sized to separate the fruits and nuts from the leaves.

10. The receiver of claim 9, further comprising:
a second deleafer to separate the leaves from the fruits or nuts after the fruits or nuts have traveled at least partially along the second conveyor.

11. The receiver of claim 10, wherein the second deleafer comprises a blower configured to blow air across the fruits and nuts as the fruits and nuts fall from the second conveyor.

12. The receiver of claim 1, wherein the conveyor belt of the desticker is configured to be taut as it conveys the objects from the first conveyor to a distal end of the desticker.

13. The receiver of claim 1, wherein:
the receiver is configured to move in a first direction of travel; and
the desticker is configured to deposit the sticks on the ground behind the receiver in an opposite direction of the first direction of travel.

14. The receiver of claim 1, wherein the desticker extends for a first length from a proximal end to a distal end, the first length being less than a second length of the first conveyor.

15. A method, comprising:
conveying, by a first conveyor, objects fallen from a tree;
separating, by a desticker positioned after the first conveyor, fruits or nuts of the objects from sticks and leaves of the objects;
conveying, by a second conveyor positioned at least partially below the desticker, the fruits or nuts away from the desticker; and
depositing the fruits or nuts in a bin or on the ground based at least in part on conveying the fruits or nuts by the second conveyor.

16. The method of claim 15, wherein separating the fruits or nuts from the sticks and the leaves further comprises:
agitating, by an agitator of the desticker, a motion of a conveyor belt of the desticker to cause the fruits or nuts to fall through openings in the conveyor belt.

17. The method of claim 15, further comprising:
spreading, by a conveyor belt of the desticker, the fruits or nuts across a surface of the second conveyor, wherein conveying, by the second conveyor, the fruits or nuts is based at least in part on spreading the fruits or nuts across the surface of the second conveyor.

18. The method of claim 15, further comprising:
deleafing, by a blower, the fruits or nuts after the fruits or nuts are conveyed by the second conveyor, wherein depositing the fruits or nuts is based at least in part on deleafing the fruits or nuts.

19. The method of claim 15, wherein separating the fruits or nuts from the sticks and the leaves further comprises:
impeding, by an impeder of the desticker, the movement of the fruits or nuts along a conveyor belt of the desticker.

20. A system, comprising:
a shaker configured to shake objects from a tree;
a receiver configured to receive the objects fallen from the tree, the receiver comprising:
a first conveyor configured to receive the objects;
a desticker positioned at an end of the first conveyor and configured to separate fruits or nuts of the objects from sticks of the objects, the desticker comprising:
a conveyor belt that comprises a plurality of openings sized to permit the fruits or nuts to pass through the conveyor belt and to prevent the sticks to pass through the conveyor belt, the conveyor belt configured to convey the objects away from the first conveyor;
an impeder to impede movement of the fruits or nuts as the conveyor belt conveys the objects away from the first conveyor;
an agitator positioned between a top portion of the conveyor belt and a bottom portion of the conveyor belt and configured to disturb a motion of the objects conveyed by the conveyor belt; and
a second conveyor configured to receive the fruits or nuts from the conveyor belt of the desticker.
